(19) United States
(12) Patent Application Publication
(10) Pub. No.: US 2010/0233048 A1
(43) Pub. Date: Sep. 16, 2010

(54) COMBINATION FILTER ELEMENT

(75) Inventors: Andrew J. Dallas, Apple Valley, MN (US); Jon D. Joriman, Little Canada, MN (US); Karthik Viswanathan, Mendota Heights, MN (US); Veli E. Kalayci, Farmington, MN (US); Ismael Ferrer, Minneapolis, MN (US)

Correspondence Address: PAULY, DEVRIES SMITH & DEFFNER, L.L.C., Plaza VII-Suite 3000, 45 South Seventh Street, MINNEAPOLIS, MN, 55402-1630, US

(73) Assignee: DONALDSON COMPANY, INC, MINNEAPOLIS, MN (US)

(21) Appl. No.: 12/526,610

(22) PCT Filed: Feb. 8, 2008
(86) PCT No.: PCT/US08/53452

§ 371 Date: May 3, 2010

Related U.S. Application Data
(60) Provisional application No. 60/889,162, filed on Feb. 9, 2007.

(51) Int. Cl. B01D 46/00; B01J 8/00; B01D 53/02; B01D 46/10; B01D 39/14

(52) U.S. Cl. 422/211; 55/486; 55/485; 96/154; 55/524

(57) ABSTRACT

A filter media for removing both chemical contaminates and particulate contaminates. The filter media includes a particulate filtration media layer which includes a fine fiber media. The filter media further includes a chemical filtration media layer.

This application is being filed as a PCT International Patent application on Feb. 8, 2008, in the name of Donaldson Company, Inc., a U.S. national corporation, applicant for the designation of all countries except the U.S., and Inventor Andrew J. Dallas, a U.S. Citizen, Inventor Jon D. Joriman, a U.S. Citizen, and Inventor Karthik Viswanathan, a India Citizen, and Inventor Veli E. Kalayci, a Turkey Citizen, and Inventor Ismael Ferrer, a Cuba Citizen, applicants for the designation of the U.S. only, and claims priority to U.S. Patent Application Ser. No. 60/889,162, titled “Combination Filter Element”, filed Feb. 9, 2007; the contents of which are herein incorporated by reference in its entirety.

### FIELD OF THE INVENTION

The invention relates to filters for filtering fluids. In particular, the invention relates to filters for removing particulate and chemical contaminates from a fluid stream.

### BACKGROUND OF THE INVENTION

Many fluid streams contain contaminants that could harm, impair, or degrade machinery, processes, or organisms. Therefore, it is desired that these contaminants be removed. However, many filters only remove one type of contaminant. For example, a filter commonly employed to filter particulate contamination may not be capable of removing chemical contaminates from a fluid stream.

There are a wide variety of applications where it is desirable or necessary to remove both particulate contamination and chemical contamination from a fluid stream. Examples of these applications include fuel cells, semiconductor tools, fab ceilings and wall grids, enclosures such as reticle stockers, disk drives, ostomy bags, hearing aids, LED devices, gas turbines, industrial air filtration, to name a few.

What is needed are improved filters that are capable of removing both particulate contamination and chemical contamination from a fluid stream.

### SUMMARY OF THE INVENTION

One aspect of the invention relates to a filter media for removing contaminants from a fluid steam. The filter includes a particulate filtration media layer, where this layer includes a fine fiber media. The filter further includes a chemical filtration media layer.

The invention may be more completely understood by considering the detailed description of various embodiments of the invention that follows in connection with the accompanying drawings.

### BRIEF DESCRIPTION OF THE DRAWINGS

FIG. 1 depicts a filter having straight channels constructed according to the principles of the present invention.

FIG. 2 depicts a filter having tapered channels constructed according to the principles of the present invention.

FIG. 3 shows a filter having a direct fluid flow through the filter media.

FIG. 4 is a graph showing the particulate captured by various filters in an experiment.

FIG. 5 is a graph showing the relationship between dust mass introduced and pressure drop of various filters in an experiment.

FIG. 6 is a graph showing the pressure drop of various filters prior to loading with particulate contaminates.

FIG. 7 is a graph showing pressure drop at various gas flow rates for various filters in an experiment.

FIG. 8 is a graph showing the concentration of a gaseous contaminate at the outlet of each of two filters as a function of time.

While the invention may be modified in many ways, specifics have been shown by way of example in the drawings and will be described in detail. It should be understood, however, that the intention is not to limit the invention to the particular embodiments described. On the contrary, the intention is to cover all modifications, equivalents, and alternatives following within the scope and spirit of the invention as defined by the claims.

### DETAILED DESCRIPTION OF THE INVENTION

In one aspect, the invention relates to a filtration element that provides both particulate and chemical filtration in the same filter volume. In one embodiment of the invention, a filtration element includes a particulate filtration layer and a chemical filtration layer. In various embodiments, the fluid flows through the particulate filtration layer first and then the chemical filtration layer, and in other embodiments, the fluid flows through the chemical filtration layer first and then the particulate filtration layer. Particulate contaminates may be captured by both the particulate filtration layer and, to an extent, the chemical filtration layer.

A filtration element constructed according to the principles of the present invention can be used in a variety of applications that desire the removal of basic contaminants from a gas stream, such as an air stream, to form a high purity gas stream. By use of the term “high purity” and modifications thereof, what is meant is a contaminant level in the cleansed gas stream of less than 1 ppm (parts per million) of contaminant. In many applications, the level desired is less than 1 ppb (parts per billion) of contaminant. A filtration element constructed according to the principles of the present invention is a “high purity element” or includes “high purity media.” In this application, such terms refer to materials that not only remove contaminants from the air stream but also do not diffuse or release any contaminants. Examples of materials that are generally not present in high purity elements or high purity media include adhesives or other polymeric materials that off-gas.

Generally, such a filtration element can be used in any application such as lithographic processes, semiconductor processing, and photographic and thermal ablative imaging processes. Proper and efficient operation of a fuel cell also desires oxidant (e.g., air) that is free of unacceptable chemical contaminants. Other applications where the contaminant-removal filter of the invention can be used include those where environmental air is cleansed for the benefit of those breathing the air. Often, these areas are enclosed spaces, such as residential, industrial or commercial spaces, airplane cabins, and automobile cabins. A further application where contaminant removal is desired is within an electronic enclosure, such as a disk drive, where the electronic components are highly sensitive to a variety of particulate and chemical contaminates.

### Particulate Filtration Layer

A variety of materials and constructions are useable for the particulate filtration layer. This layer can include fibrous filtration media that can be characterized as “fine fiber” media. An example of a suitable fine fiber media is a media constructed from nanofibers in the range of 0.001 microns to 5 microns diameter. Additionally, a fine fiber media can be constructed from other fibers that are not considered to be nanofibers and have a diameter greater than 5 microns. In general, for typical constructions according to the present invention, it is foreseen that the fine fiber component will be provided with fiber diameters of 8 microns or less, typically less than 5.0 microns, and preferably about 0.1-3.0 microns depending upon the particular arrangement chosen. Furthermore, the fine fiber layer may be provided in a layer that ranges, for example, from 0.1 micron to 20 microns thick.

The material used for the fibers should be a material that can be readily formed into fibers with relatively small diameters, and should be capable of being formed into a web or network of such fine fibers. Furthermore, the fiber material should be sufficiently strong to remain intact during handling and during the filtering operation, and should also be capable of being readily applied to various supporting structures or other layers of the filter. Example materials for the fine fiber media include polymeric, glass, cellulosic, ceramic, carbon, polypropylene, PVC, and polyamide. More specifically, polyacrylonitrile can be used; polyvinyladine chloride available from Dow Chemicals, Midland, Mich. as Seran® F-150 can also be used. Other suitable synthetic polymeric fibers can be used to make very fine fibers including polysulfone, sulfonated polysulfone, polyimid, polyvinylidine fluoride, polyvinyl chloride, chlorinated polyvinyl chloride, polycarbonate, nylon, aromatic nylons, cellulose esters, aerolate, polystyrene, polyvinyl butyryl, polyvinyl alcohol, polyethylene oxide, and copolymers of these various polymers. Fibers may also be formed from ceramics such as titanates

In some embodiments, the fine fibers can be secured to a coarse support to provide supporting structure. The technique used may depend, in part, on the process used for making the fine fibers or web, and the material(s) from which the fine fibers and coarse fibers are formed. For example, the fine fibers can be secured to a coarse support by an adhesive or they may be thermally fused to coarse fibers. Coarse bicomponent fibers with a meltable sheath could be used to thermally bond the fine fibers to coarse fibers. Solvent bonding may be used, thermal binder fiber techniques may be applicable, and autogenous adhesion may be used. For adhesives, wet-laid water soluble or solvent based resin systems can be used. Urethane sprays, hot melt sprays, or hot melt sheets may be used in some systems. In some instances, it is foreseen that adhesives for positive securement of the fine fiber web to a coarse support will not be needed. These will at least include systems in which, when the overall composition is made, the fine fiber is secured between layers of coarse material, and this positioning between the two coarse layers is used to secure the fine fiber layer or web in place.

Herein reference is made to the fine fiber layer comprising “fine fibers” or a “network or web” of fine fibers. The term “network” or “web” of fine fibers in this context is meant to not only refer to a material comprising individual fine fibers, but also to a web or network wherein the material comprises fine fibers or fibrils which join or intersect one another at nodes or intersections.

In some embodiments of the invention, a layer of media will include a coarse support or matrix having a layer or web of fine fibers secured to at least one surface thereof. The coarse support (or matrix) and fine fibers may be generally as previously described. The overall layer may be characterized in a variety of manners, including, for example, simply as comprising coarse and fine fibers as described.

A variety of methods can be utilized to prepare stacked arrangements having layers of fine and coarse fibers. In some, for example, the layers can be wet-laid to achieve the stacked arrangement, resulting in some entanglement of the fine and the coarse fibers. The degree of entanglement would not be to such an extent that the fine and coarse fibers would be a “homogenous mix” or the media would not perform desirably. In general the coarse layers would still be used to separate the various fine fiber layers from one another, in the arrangement. Herein, when the fine fiber layers are described as “discrete” relative to one another and relative to the coarse fiber layers, it is not meant that there is absolutely no entanglement, but rather the construction is such that the multi-layer, i.e. separated fine fiber layer, environment is provided for filtration, as the fluid to be filtered passes through the arrangement. In general this will mean (when the layers are discrete) that such entanglement that may occur is relatively low. Generally the entanglement between the fine fiber layers and coarse fiber layers, if it occurs at all, will only involve a relatively small percent by weight of the fine fibers, typically less than 15%.

As a result of possessing such structure, a homogenous filter media is not presented to the air flow. That is, as the air passes through the filter arrangement, at various depths or levels, different materials are encountered. For example, in some systems the air would pass through alternating rows of fine fiber material and coarse material, as it passes through the system. Advantages may result from this construction.

In typical arrangements, the composite layer of media may be characterized with respect to the mass of fine fiber applied per unit area of a surface of a coarse support or scrim. This is sometimes referred to as the basis weight of the fine fiber layer. Such a characterization will be varied depending upon the particular fiber diameter used, the particular material chosen and the fiber diameter and the particular fine fiber population density or filter efficiency desired for the layer. It is foreseen that in typical constructions having fine fiber diameters of about 0.1 to 5.0 microns, the mass of material from which the fine fibers are formed, applied per unit surface area of a scrim or coarse support (or matrix), will be within the range of about 0.2 to 25 g/m², regardless of the particular material used.

This polymer has improved physical and chemical stability. The polymer fine fiber (microfiber and nanofiber) can be fashioned into useful product formats. Nanofiber is a fiber with diameter generally less than 200 nanometer or 0.2 micron. Microfiber is a fiber with diameter generally larger than 0.2 micron, but not generally larger than 10 microns. This fine fiber can be made in the form of an improved multi-layer microfiltration media structure. The fine fiber layers of the invention comprise a random distribution of fine fibers which can be bonded to form an interlocking net. Filtration performance is obtained largely as a result of the fine fiber barrier to the passage of particulate. Structural properties of stiffness, strength, and pleatability may be provided by the substrate to which the fine fiber is adhered. The fine fiber interlocking networks have as important characteristics, fine fibers in the form of microfibers or nanofibers and relatively small spaces between the fibers. Such spaces typically range, between fibers, of about 0.01 to about 25 microns or often about 0.1 to about 10 microns. The filter products comprising a fine fiber layer and a cellulosic layer are thin with a choice of appropriate substrate. The fine fiber adds less than a micron in thickness to the overall fine fiber plus substrate filter media. In service, the filters can stop incident particulate from passing through the fine fiber layer and can attain substantial surface loadings of trapped particles. The particles comprising dust or other incident particulates rapidly form a dust cake on the fine fiber surface and maintains high initial and overall efficiency of particulate removal. Even with relatively fine contaminants having a particle size of about 0.01 to about 1 micron, the filter media comprising the fine fiber has a very high dust capacity.

The polymer materials as disclosed herein have resistance to the undesirable effects of heat, humidity, high flow rates, reverse pulse cleaning, operational abrasion, submicron particulates, cleaning of filters in use and other demanding conditions. The microfiber and nanofiber performance is a result of the character of the polymeric materials forming the microfiber or nanofiber. Further, filter media using the polymeric materials may provide higher efficiency, lower flow restriction, high durability (stress related or environmentally related) in the presence of abrasive particulates and a smooth outer surface free of loose fibers or fibrils. The overall structure of the filter materials provides a thin media allowing advantageous media area per unit volume, reduced velocity through the media, improved media efficiency and reduced flow restrictions.

In some embodiments, chemical treatments may be provided internal to the fiber or on the external surface of the fiber. Ceramic and carbon fibers can be nanofibrous and/or fall into the category of nanotubes, buckytubes, nanowires, and nanohorns. These fibrous materials can be organized in any range or combination to provide the required application performance. This layer can be placed on both sides of the channel wall, entrance and exit. Additionally, this fibrous layer can have inert or active particles added in order to either deliver benefits for particulate or chemical filtration. Besides particulate filtration performance the particulate fibrous layer can provide additional benefits such as chemical performance, control of humidity in the fibrous layer, deliver additives into the airstream such as odorous or reactive species that provide a desirable attribute for the specific application.

### Chemical Filtration Layer

A variety of materials are useable for the chemical filtration layer. Example materials for the chemical filtration layer include polymer, cellulosic, ceramic, glass, or carbon fibers. Additionally, the fibers of this layer are treated to provide chemical removal capabilities, such as through physical adsorption, chemical adsorption, or catalytic reactions. In one embodiment, the fibers that form the chemical filtration layer can be impregnated or coated with reactive materials that are designed to remove the desired chemical species, such as acids, bases, and polar and non-polar volatile organics. These reactive materials may be configured to be highly reactive or may be relatively inert depending on the desired performance characteristics of the filter. The reactive materials may be applied to the fibers of the chemical filtration layer by a variety of coating techniques, such as dip coating, saturation coating, kiss coating, spray coating, plasma coating, or chemical vapor deposition.

Certain applications of the present invention are directed to a contaminant-removal filter having an acidic material and a preservative or stabilizer. In some filters, acidic materials in the filter element often do not have an acceptable contaminant-removal life and the life of such filters may be shortened by the presence of moisture within the filter. However, the inclusion of a preservative or stabilizer with the acidic material increases the useful life of the filter. Although not being bound by theory, Applicants believe that the preservative or stabilizer inhibits the growth of microbial organisms such a mold, bacteria and viruses on the filter substrate, thus extending the use life of the filter.

In example embodiments, present at least on the surface of the substrate, and preferably within the substrate, is an acidic or basic material. A desirable acidic material is citric acid. The acidic material reacts with or otherwise removes basic contaminants from air or other gaseous fluid that contacts the filter. When a basic material is used, it can remove acidic contaminants from air or other gaseous fluid that contacts the filter. Also present on at least the surface, and preferably within the substrate, is at least one of a preservative and a stabilizer. Generally, this preservative or stabilizer is homogeneously present with the acidic material. A preferred stabilizer is polyacrylic acid (PAA). A preferred preservative is sodium benzoate.

In one particular aspect, the combination filter element includes a contaminant-removal filter portion comprising a fibrous substrate, and citric acid and at least one of a preservative and a stabilizer throughout the substrate. The preservative can be, for example, sodium benzoate, potassium nitrate, sodium propionate, potassium nitrite, sodium sulfite, or sodium sulfate, and the stabilizer can be polyacrylic acid. The ratio of the citric acid to the preservative can be 1:1 to 5000:1, and the ratio of the citric acid to the stabilizer can be 1:1 to 50:1. Including both a preservative and stabilizer may modify these ratios.

Examples of suitable acidic materials for use in the element of the invention include carboxylic acids (mono-, di-, tri-, and multi-acids; linear, branched, and cyclic forms) such as citric acid, oxalic acid, malonic acid, and higher homologs, aromatic carboxylic acids; sulfonic acids (linear, cyclic, and aromatic); inorganic acids such as sulfuric acid, phosphoric acid, nitric acid, hydrochloric acid; heteropolyacids (superacids). Citric acid is a preferred acidic material. Examples of suitable basic materials include potassium iodide, potassium carbonate, tributyl ammonium hydroxide, piperidine, piperazine, and other heterocyclic amines.

The level of acidic material within the impregnate solution is selected based on the acidic material and the substrate being used. The amount of acidic material in the solution is at least about 0.5 wt-% and is no more than about 75 wt-%. Preferably, the amount of acidic material is 10-50 wt-%. For the preferred acidic material, citric acid, the amount of citric acid is about 10-50 wt-%, preferably 15-35 wt-%. Other levels of acid would also be suitable.

It has been found that lower concentrations of acidic material are generally preferred over higher concentrations. For example, a solution having 5-15 wt-% citric acid is preferred over a solution having 20-35 wt-% citric acid. In a particular example, it was found that impregnating a substrate with a 5% aqueous citric acid solution, drying the substrate, and then impregnating with a 12% aqueous citric acid solution provided better basic-contaminant removal than a single step impregnation with a 25% citric acid solution. This lower concentration, double-step impregnation process is also preferred over a single step impregnation process.

Although the terms “impregnation”, impregnate”, and the like have been used, it should be understood that the method of application of the acidic or basic material to the substrate is not limited to impregnation. Other methods may be used to provide the acidic or basic material into the substrate. Other alternate and suitable methods for applying the acidic or basic material into the substrate include immersion, spraying, brushing, knife coating, kiss coating, plasma coating, chemical vapor deposition, and other methods that are known for applying a liquid onto a surface or substrate. The impregnation or other application method can be done at atmospheric conditions, or under pressure or vacuum.

After being impregnated, the substrate is at least partially dried to remove solvent (e.g., water), leaving acidic or basic material in and on the substrate. Preferably, at least 90% all free water or other solvent is removed, and most preferably, at least 95% of all free water or other solvent is removed.

The acidic or basic material is desirably present on and within at least 50% of the surface area of the passages 20 of the element. Preferably, the acidic or basic material is present on and within at least 55 to 75% of the passage wall surfaces, more preferably at least 90% of the surfaces, and most preferably, is continuous and contiguous with no areas without the acidic material. The acidic or basic material is present through at least 10% of the thickness of the substrate. Preferably, the acidic or basic material is present through at least 50% of the substrate, and more preferably through at least 80%.

In some embodiments, the chemical filtration layer is formed from or contains particulate filtration media. For example, the chemical filtration layer could be composed of carbon particles. Other usable particulates include zeolites, clays, ion exchange resins, or catalysts. In some embodiments, the particulate filtration media is a coated media. In some further embodiments, the chemical filtration layer include metal oxides

### Filter Configurations

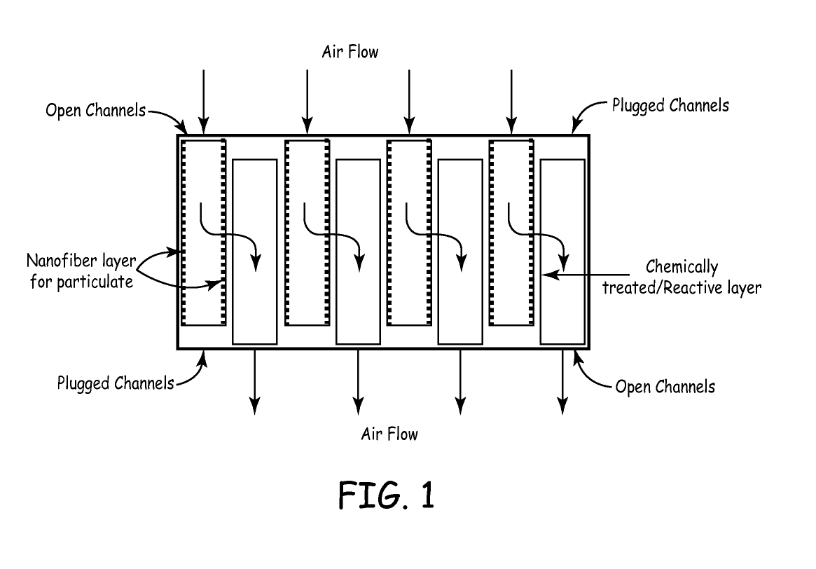

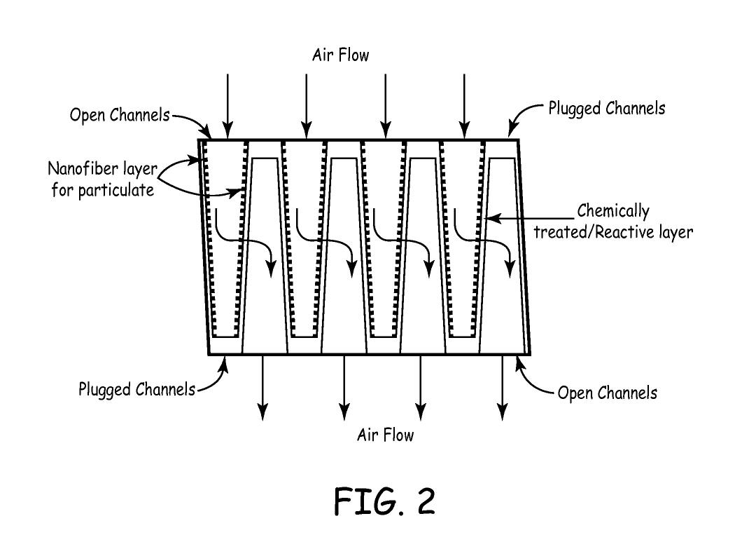

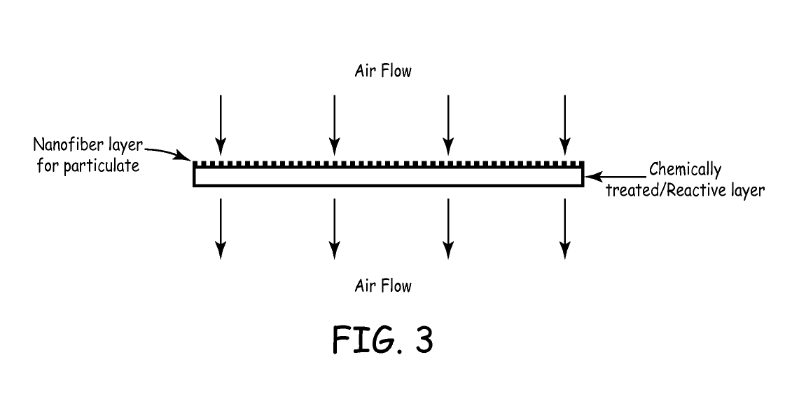

One embodiment of a filter constructed using filter media of the present invention is an alternating flow channel type filter. One manner of forming such a filter is to provide filter media having a corrugated texture, and to roll or otherwise form a compacted filter arrangement where the corrugations define flow channels. Typically channels formed in this way have an alternating open and closed configuration, such that channels open at one end will be closed at the other end. This requires that a fluid flowing through an opening at one end pass through the filter media in order to flow out of a channel open at the opposite end. In this way, contaminates present in the fluid will be filtered. This type of flow may be referred to as a “Z” type flow; where flow is directed along a channel, but in order to exit the device the flow must traverse the layer, and exit through a subsequent channel. The channel shape can be straight and the channels can be aligned as shown in FIG. 1. However, the channel can also be tapered as shown in FIG. 2. The channel opening can be of any shape, such as round, triangular, square, rounded triangular, hexagonal, etc. Generally the airflow does not need to be perpendicular to the layers, but it must traverse the layers. In a separate embodiment, the fluid flow may be directly passed through the filter, as is shown in FIG. 3. Filters constructed in this manner may be generally flat, pleated, or other configurations.

In certain embodiments a substrate forming the particulate filtration layer is a cellulosic or polymeric material, or a combination thereof. The body of the filter, formed by the substrate, is preferably configured with a plurality of passages extending from an inlet face to an outlet face, the passages providing a pathway for gas flow therethrough.

In another particular aspect, the invention is to a contaminant-removal filter element comprising a fibrous substrate having a first face defining an inlet, a second face defining an outlet, and a plurality of passages extending from the first face to the second face. Acidic material, such as citric acid, or a basic material, and preservative and/or stabilizer are throughout the substrate.

In some embodiments, the fine fiber media is sandwiched between a first chemical filtration layer and a second chemical filtration layer. In other embodiments, the chemical filtration layer is sandwiched between a first fine fiber media layer and a second fine fiber media layer.

A filter constructed according to the principles of the present invention is suitable for use in many applications. For example, such a filter may be used in conjunction with fuel cells, semiconductor tools, fab ceilings and wall grids, enclosures such as reticle stockers, disk drives, ostomy bags, hearing aids, LED devices, gas turbines, and industrial air filtration.

### Experimental Performance

A filter constructed according to the principles of the present invention was constructed and tested experimentally. The experimental filter was tested for dust loading capability. The test involved introducing standard ISO fine test dust into an airstream of 35 cubic feet per minute (CFM) by a deflocculated feed system until the restriction across the filter reached 10 inches of water pressure drop. The dust was introduced at a rate of 1.0 gram per minute. The pressure drop during the test was monitored, as well as the mass of dust introduced into the airstream. Furthermore, the mass of the filter was determined both before the test and after the test to determine the mass of particulate captured by the filter. A variety of other filters, including conventional filters, were tested simultaneously for comparison. For example, filters that can be referred to as “A”, “B”, and “C” were 3.75 inch depth filters of a filter material having chemical removal properties, filter “D” was a 7.5 inch deep filter having chemical removal properties, and filter “E” was a 7.0 inch deep filter constructed according to the principles of the present invention.

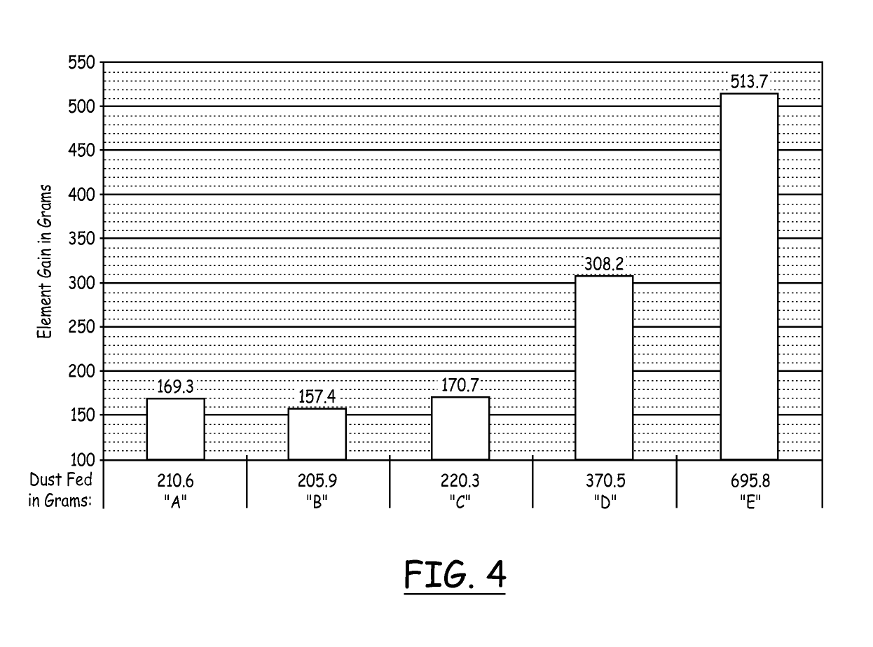

FIG. 4 shows the mass of dust captured by each filter at the conclusion of the test when the pressure drop across the filter reached 10 inches of water. As can be seen, filters A, B, and C have relatively low particulate capture for a given pressure drop. Element D has somewhat better particulate capture. However, element E constructed according to the principles of the present invention has substantially greater particulate capture at the target pressure drop limit. This indicates that this filter construction is well-suited to capture of particulate contaminants with low pressure drop at higher loadings.

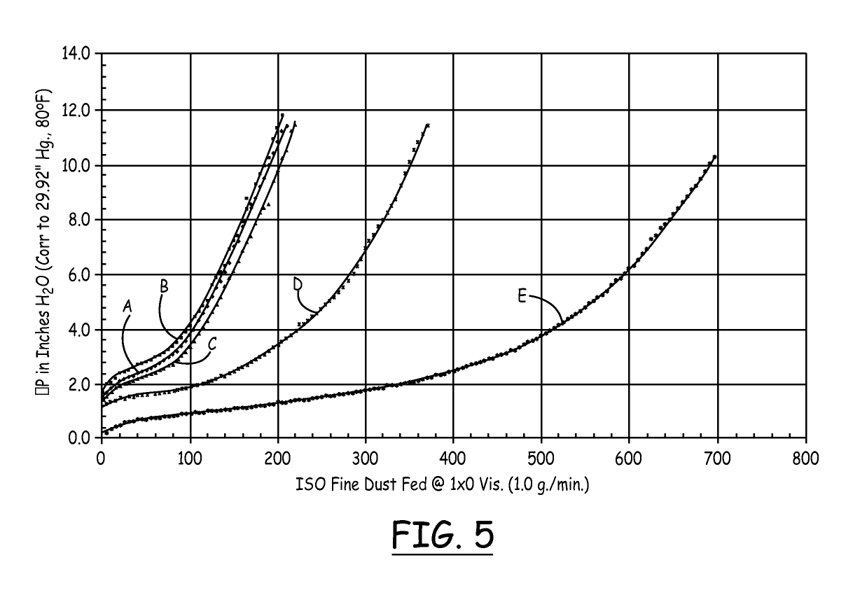

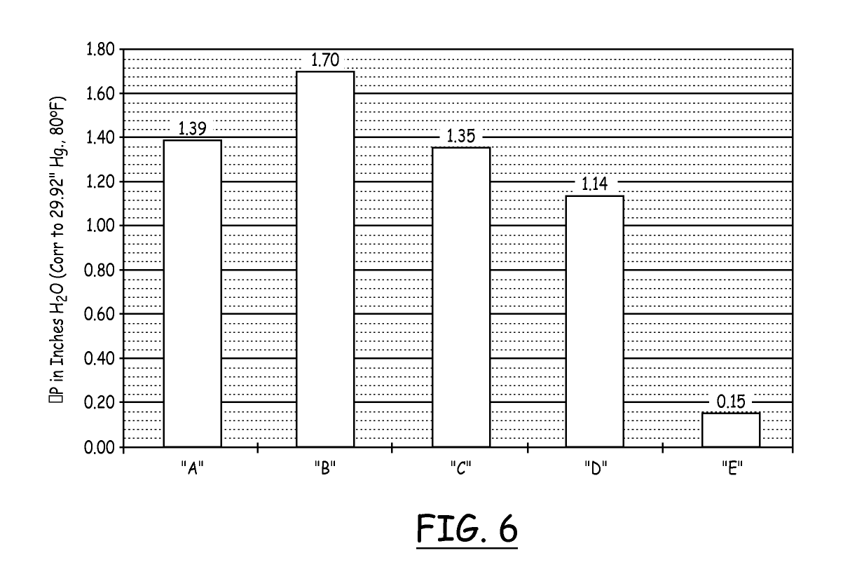

FIG. 5 shows measured pressure drop across the filter over the course of the experiment. As can be seen, filter “E” produces significantly lower pressure drop increase relative to the other filters tested. FIG. 6 shows the initial pressure drop of each filter, before dust introduction. As can be seen, filter “E” has significantly lower pressure drop to begin with.

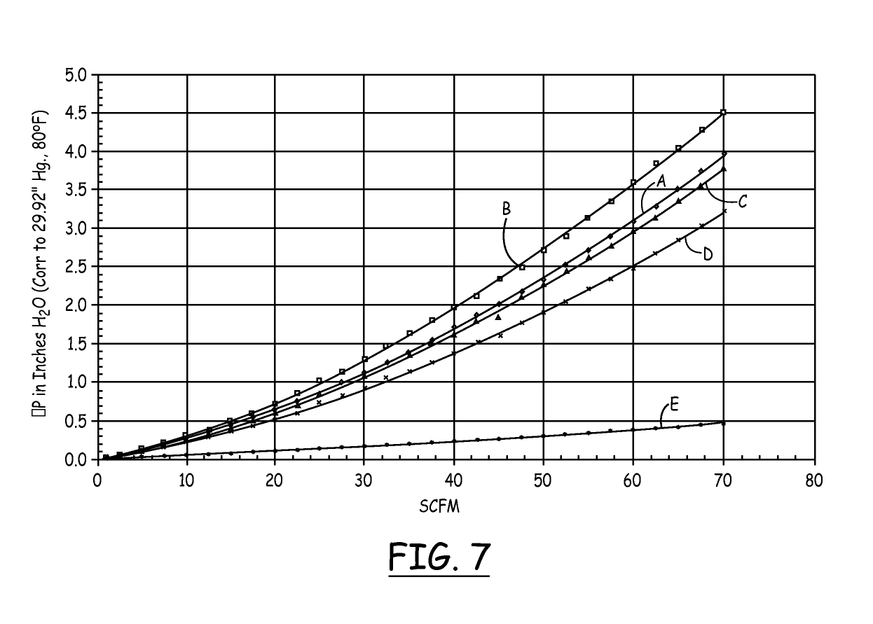

The relationship between air flow and pressure drop across the filter was tested prior to loading the filters. The pressure drop across each filter was tested over a range of 1.0 CFM to 70 CFM. As can be seen in FIG. 7, filter “E” exhibited significantly lower pressure drop with increases in air flow rate.

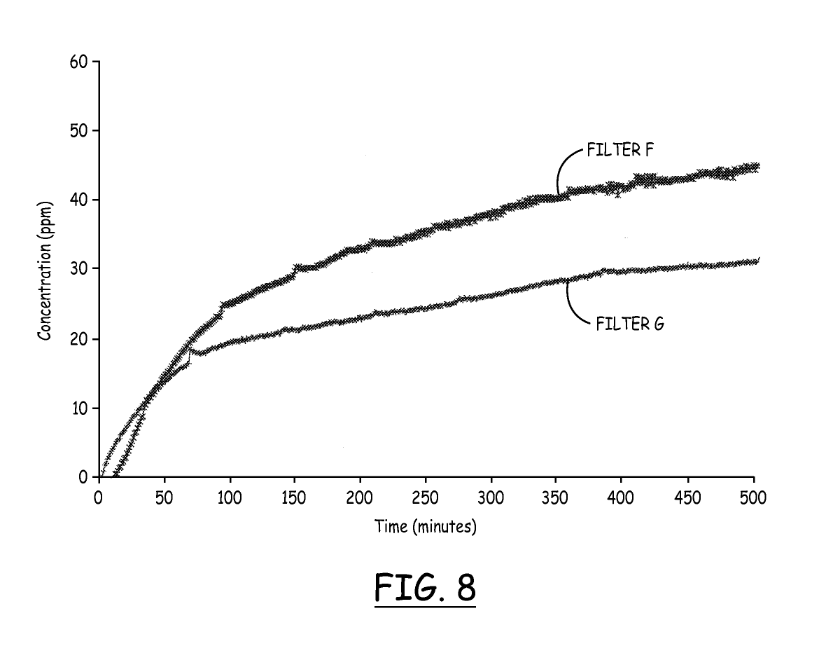

Chemical breakthrough testing was also performed to evaluate the ability of a filter to capture a chemical contaminant such as SO₂. This experiment involved introducing 50 ppm of SO₂ at a flow rate of 30 liters per minute at 50 percent relative humidity and an air temperature of 25 deg. Celsius. The filter elements tested were fluted in an open channel format, having a depth of 2 inches and being in a holder that is 1.5 inches in diameter. For this experiment, a filter element that can be referred to as filter “F” was tested that did not include a fine fiber filter media, and a filter element that can be referred to as filter “G” was tested that did include a fine fiber filter media. The concentration of SO₂ at the outlet of the filter was monitored over time. The results of this experiment are shown in FIG. 8. It can be seen that filter G was substantially more effective at reducing the concentration of SO₂ in the gas stream as evidenced by the lower concentrations at the filter outlet.

The present invention should not be considered limited to the particular examples described above, but rather should be understood to cover all aspects of the invention as fairly set out in the attached claims. Various modifications, equivalent processes, as well as numerous structures to which the present invention may be applicable will be readily apparent to those of skill in the art to which the present invention is directed upon review of the present specification. The claims are intended to cover such modifications and devices.

The above specification provides a complete description of the structure and use of the invention. Since many of the embodiments of the invention can be made without parting from the spirit and scope of the invention, the invention resides in the claims.

What is claimed is:

1. A filter media for removing contaminants from a fluid steam, the filter comprising:
a particulate filtration media layer comprising a fine fiber media; and
a chemical filtration media layer.

2. The filter media of claim 1, where the particulate filtration media layer is constructed from fibers having a diameter of about 0.001 microns to 5 microns.

3. The filter media of claim 1, where the fine fiber media is a layer 0.1 micron to 20 microns thick.

4. The filter media of claim 1, where the fine fiber media is constructed from fibers made of polyacrylonitrile, polyvinyladine, polysulfone, sulfonated polysulfone, polyimid, polyvinylidine fluoride, polyvinyl chloride, chlorinated polyvinyl chloride, polycarbonate, nylon, aromatic nylons, cellulose esters, aerolate, polystyrene, polyvinyl butyryl, polyvinyl alcohol, or polyethylene oxide.

5. The filter media of claim 1, where the fine fiber media includes a web of fine fibers.

6. The filter media of claim 1, where the chemical filtration media is constructed from fibers made from polymer, cellulosic, ceramic, glass, or carbon fibers.

7. The filter media of claim 1, where the chemical filtration media includes fibers coated with chemically-reactive impregnant.

8. The filter media of claim 7, where the chemically-reactive impregnant is an acidic material.

9. The filter media of claim 8, where the acidic material is citric acid.

10. The filter media of claim 9, where the citric acid is 15 to 35 percent by weight of the impregnant.

11. The filter media of claim 7, where the chemically-reactive material is a basic material.

12. The filter media of claim 7, where the chemically-reactive material is applied to fibers by dip coating, saturation coating, kiss coating, spray coating, plasma coating, or chemical vapor deposition.

13. The filter media of claim 1, where the fine fiber media is positioned to be upstream in a gas flow from the chemical filtration layer.

14. The filter media of claim 1, where the chemical filtration layer is positioned to be upstream in a gas flow from the fine fiber media.

15. The filter media of claim 1, where the fine fiber media is sandwiched between a first chemical filtration layer and a second chemical filtration layer.

16. The filter media of claim 1, where the chemical filtration layer is sandwiched between a first fine fiber media layer and a second fine fiber media layer.

17. The filter media of claim 1, where the chemical filtration layer comprises a particulate containing layer.

18. The filter media of claim 17, where the particulate containing layer comprises zeolites, clays, ion exchange resins, catalysts, or carbon particles.

19. The filter media of claim 17, where the particulate containing layer comprises coated particulates.

20. The filter media of claim 17, where the chemical filtration layer comprises metal oxides.

21. The filter media of claim 17, where the fine fiber media is coated with chemically-reactive impregnant.
